(19) United States
(12) Patent Application Publication
(10) Pub. No.: US 2006/0036486 A1
(43) Pub. Date: Feb. 16, 2006

(54) Method of business

(76) Inventor: Jerry A. Ehr, Bloomington, MN (US)

Correspondence Address: Angenehm Law Firm, Ltd., P.O. Box 48755, Coon Rapids, MN, 55448-0755, US

(21) Appl. No.: 10/920,156

(22) Filed: Aug. 16, 2004

(51) Int. Cl. G06Q 30/00; G06Q 99/00

(52) U.S. Cl. 705/14; 705/1

(57) ABSTRACT

A method of business including the steps of initiating a transaction to transfer real property of a client through a realtor; placing a classified ad to sell personal property of a client, the classified ad including information about where the personal property may be viewed online; paying for the classified ad with client funds; and uploading a picture of the personal property on a personal property webpage of a realtor website, such website having at least one URL and such URL being included in the classified ad.

### FIELD OF THE INVENTION

The present invention relates to business methods and more particularly to synergistic buying and selling of real and personal property with the involvement of a realtor and property owner in the real and electronic worlds.

### BACKGROUND OF THE INVENTION

Buying and selling real property, typically homes, is a big decision. Generally, the decision extends well beyond size and features of a home and into how a home will impact on the personal property of the homeowner. The size of the new home may require purchase or sale of furniture. Coloration of the new home may either need to be changed to accommodate the existing personal property or the personal property is changed to accommodate the coloration of the new home. So common are these problems that “decorating allowances” have long been part of a sale of real property where a decorating allowance allows the home purchaser extra money to either alter the home or purchase new furniture to fit the new home and incorporate the associated expense into the mortgage.

A home owner may be selling a home colored in warm tones, perhaps including a red-ish brick fireplace, pink bathroom tiles, and burnt cina linoleums. Matching furniture will generally be in warm tones to avoid color conflicts. Green or blue furniture creates a visual conflict. Thus, the party buying the home may need to get rid of personal property that would clash with the home. The seller may be moving to a new home with cool colors and likewise need to sell personal property. While the the home transaction may include some of the personal property, such is not always the case and the personal property is sold separately.

Another homeowner may be selling their home and moving a great distance away. Packing and moving the large items of personal property may not be worth the expense. Consequently, the personal property is sold while the home is being sold. New personal property is purchased upon arrival at the point of relocation.

Many families experience a point of downsizing when the children move away. All the added space and furniture needed when the children were around is now wasted space. Consequently a smaller home may be purchased and the larger home sold. Excess furniture does not always fit into the smaller home. Here again, a transaction in real property causes a need to transact in personal property.

Typically, personal property is sold through classified ads, placed in newspapers, and local circulars. The ads are small, perhaps only one column inch. Pictures of the personal property are not included, but rather a limited description thereof. If a person would like to see the personal property, they must call and go to the location of the property and physically see it. This is time consuming and wasteful when one is trying to furnish a home.

Consignment shops have developed which allows one to see multiple pieces of personal property in one visit. This can be problematic for the property owner as they must leave their property where they cannot care for it. Moreover, the property owner is limited in what they can sell by the limitations of what the consignment shop agrees to offer for sale.

Alternatively, a personal property owner may sell the personal property online on website such as e-bay. However, such websites tend to draw consumers from around the country and the world. Thus, transfer of the property may involve packing and shipping large pieces of personal property long distances. More likely, most of those viewing the personal property will not purchase due to the shipping problems.

What is needed is a manner of better connecting the real property market and the personal property market. Preferably, the market for the personal property is held local, like the real property, easing delivery of large items. Desirably, pictures of the real and personal property are displayed in the same location such that a prospective purchaser of a home can better envision what the personal property will look like when associated with the real property, inducing a sale of both to one buyer.

### SUMMARY OF THE INVENTION

The present invention is a method of advertising, including the steps of initiating a transaction to transfer real property through a realtor, the realtor having a website; initiating a classified ad transaction to transfer ownership of personal property of personal property owner, the classified ad including a URL of the realtor website; paying for the classified ad with funds of the personal property owner; and uploading a picture of the personal property on a personal property webpage of the realtor website.

Advantageously, an owner of personal property can have a website displaying the personal property.

Also as an advantage, the real estate agent, offering the webpage, receives real world promotion of the realtor's website.

As still yet a further advantage, the website is available at perhaps the most common time for transfer of personal property, e.g., during the transfer of real property.

These and other advantages will become clear from reading the description of the preferred embodiment.

### DETAILED DESCRIPTION

Definitions

The following terms shall have the following meaning throughout the description and the claims.

Classified Ad—has the traditional meaning, namely a real world print media advertisement.

Online—using a global computer network.

Personal property—In a broad and general sense, everything that is subject of ownership, not coming under denomination of real estate. A right or interest in things personal, or right or interest less than a freehold in realty, or any right or interest which one has in movable things. Black's Law Dictionary, Special Deluxe 5^{th} Edition, p. 1096

Real Property or Real Estate—Land, and generally whatever is erected or growing upon or affixed to land. Also rights growing out of, annexed to, and exercisable within or about land. A general term for lands tenements, and hereditaments; property which, on the death of the owner intestate, passes to his heir. Black's Law Dictionary, Special Deluxe 5^{th} Edition, p. 1096

Real world—those parts of the world that are accessible without use of a global computer network, e.g. the internet.

Realtor—an entity licensed to transact for others in real property.

Website—a group of at least one related page, typically multiple pages, of data, having common ownership, accessible from a global computer network, e.g. the internet.

Webpage—a portion of a website with a distinct URL associated with a higher level URL. One or more webpages constitutes a website. Webpage is interpreted to include alternative forms including pop-up windows.

### DESCRIPTION OF THE PREFERRED EMBODIMENT

The present invention is a method of advertising. A real estate transaction may be initiated between a real estate or real property owner and a realtor. Typically, an agency agreement is signed at this point where the real estate agent agrees to represent the real estate owner in the sale or purchase of real estate. This agreement may be to engage the real estate agent as a seller's agent, buyer's agent, may be limited agency or dual agency. Alternatively, the real estate agent may be engaged as a facilitator or other representative.

Next, the personal property owner places one or more classified ads to sell the personal property. The owner of the personal property desirably is the real property owner. Such ad is placed in typical print media such as newspapers and local circulars and is written describing the personal property being offered for sale in the manner determined by the personal property owner. The classified ad includes information about where the personal property may be viewed online, e.g. the realtor website. The ad may be, and preferably is, paid for with the funds of the personal property owner. In this manner the realtor may have multiple clients each placing a classified ad to sell at least one piece of personal property with each ad identifying a URL of the realtor website. The URL may be the page where the personal property is shown or another page within the website.

At least one picture and information about the real estate may be on a real property webpage of a realtor website and a picture of the personal property may be uploaded on a personal property webpage of the realtor website. As many pictures as desired and perhaps optimally four or so pictures may relate to one piece of personal property. In one embodiment the real property and personal property webpages may be the same page, although it is preferable to have them on separate pages. In one embodiment, there may be one piece of personal property on each personal property webpage, although it is normally desirable to include all personal property on a single page. The pages may be interconnected in manners known in the art, such that a prospective buyer of the real estate may view potential personal property that was previously used in the home. A URL associated with the personal property page, either directly or indirectly, may be included in the classified ad, allowing a prospective purchaser of the personal property to view the personal property without travel.

The real property and personal property webpages may be electronically connected. In one manner, the real property and personal property pages may be joined into one page. Alternatively and more preferably, the pages are separate and are linked such that clicking a mouse button pulls either page into view. Note that a webpage may be in the form of a pop-up, such that the personal property may be viewed in conjunction with the real property, giving a prospective buyer of the real property a chance to view what a previous owner thought looked nice in the home. The real property webpage may be interlinked with additional webpages of the realtor website.

The personal property owner may desire to write the text to be placed on the personal property webpage. In this manner the personal property owner may place the text of the classified ad onto the webpage, further correlating the classified ad and the online viewing of the personal property. Additional information and opportunities to purchase online may also be included. The realtor may charge a commission or other fee for personal property sold from the realtor website.

Although the present invention has been described with reference to preferred embodiments, workers skilled in the art will recognize changes may be made in form and detail without departing from the spirit and scope of the invention.

I claim:

1. A method of advertising, comprising:
selling real estate of an owner through a realtor;
placing a classified ad to sell a piece of personal property of the owner, the classified ad including information about where the personal property may be viewed online;
paying for the ad with owner funds;
uploading a picture and information about the real estate on a real property webpage of a realtor website, uploading a picture of the personal property on a personal webpage of the realtor website, such personal webpage having an associated URL and such URL being included in the classified ad;
electronically connecting the real property webpage to the personal property webpage;
allowing the owner to determine the text on the personal property webpage; and
interlinking the real property webpage with additional webpages of the realtor website.

2. The method of claim 1 further comprising the step of:
placing multiple classified ads to sell the personal property of the owner, the classified ads including information about where the personal property may be viewed online.

3. The method of claim 1 further comprising the step of:
placing the classified ad to sell multiple pieces of personal property of the owner, each classified ad including information about where the personal property may be viewed online.

4. The method of claim 1 further comprising the step of:
paying for the personal property webpage with funds of the personal property owner.

5. The method of claim 1 wherein the realtor has multiple personal property webpages.

6. The method of claim 1 further comprising the step of:
purchasing personal property from the realtor website.

7. The method of claim 6 further comprising the step of:
charging a commission on personal property purchased from the realtor website.

8. A method of advertising, comprising:
initiating a transaction to transfer real property of a client through a realtor;
placing a classified ad to sell personal property of a client at the initiation of the client, the classified ad including information about where the personal property may be viewed online; and
uploading a picture of the personal property on a personal property webpage of a realtor website, such website having at least one associated URL and such URL being included in the classified ad.

9. The method of claim 8, wherein the step of:
initiating a real property transaction through the realtor is a sale transaction.

10. The method of claim 8, wherein the step of:
initiating a real property transaction through the realtor is a purchase transaction.

11. The method of claim 8 further including the step of:
placing multiple classified ads to sell the personal property.

12. The method of claim 8 further including the step of:
placing the classified ad to sell multiple pieces of personal property.

13. The method of claim 8 further including the step of:
multiple clients each placing a classified ad to sell at least one piece of personal property, each ad identifying the URL.

14. The method of claim 8 further comprising the step of:
selling the personal property on the realtor website.

15. A method of advertising, comprising:
initiating a transaction to transfer real property through a realtor, the realtor having a website;
initiating a classified ad transaction to transfer ownership of personal property of personal property owner, the classified ad including a URL of the realtor website; and
uploading a picture of the personal property on a personal property webpage of the realtor website.

16. The method of claim 15, further wherein the step of:
initiating the transaction to transfer real property is a sale transaction.

17. The method of claim 15, further wherein the step of:
initiating the transaction to transfer real property is a purchase transaction.

18. The method of claim 15 wherein the step of:
initiating a classified ad transaction to transfer ownership of personal property is a transaction to sell the personal property.

19. The method of claim 15 wherein the personal property owner is the owner of the real property.

20. The method of claim 15 further including the step of:
placing multiple classified ads to sell the piece of personal property.
